(19) United States
(12) Patent Application Publication
(10) Pub. No.: US 2003/0228003 A1
(43) Pub. Date: Dec. 11, 2003

(54) Silent phone

(76) Inventor: Robert Colin Vardon, Sun City, CA (US)

Correspondence Address: ROBERT VARDON, # 358, 27250 MURRIETA RD, SUN CITY, CA, 92586, US

(21) Appl. No.: 10/358,974

(22) Filed: May 13, 2003

Related U.S. Application Data
(60) Provisional application No. 60/386,529, filed on Jun. 7, 2002.

(51) Int. Cl. H04M 11/00

(52) U.S. Cl. 379/88.14

(57) ABSTRACT

Silent Phone would be equipped with a keypad consisting of 12 keys, which would light up as they were touched when making a call and stay lighted until the phone was hung up. A light on the phone would show a call was there to be answered, a vibrator would activate to alert the person of the incoming call. A scroll would show the message and a printer to print the message. Other features would include an internal memory, a speech recognition program, wiring, a circuit board, a long cord that could be plugged into a jack and a handset with a diaphragm to serve as a microphone. Silent Phone could also be produced in a second version resembling a cell phone.

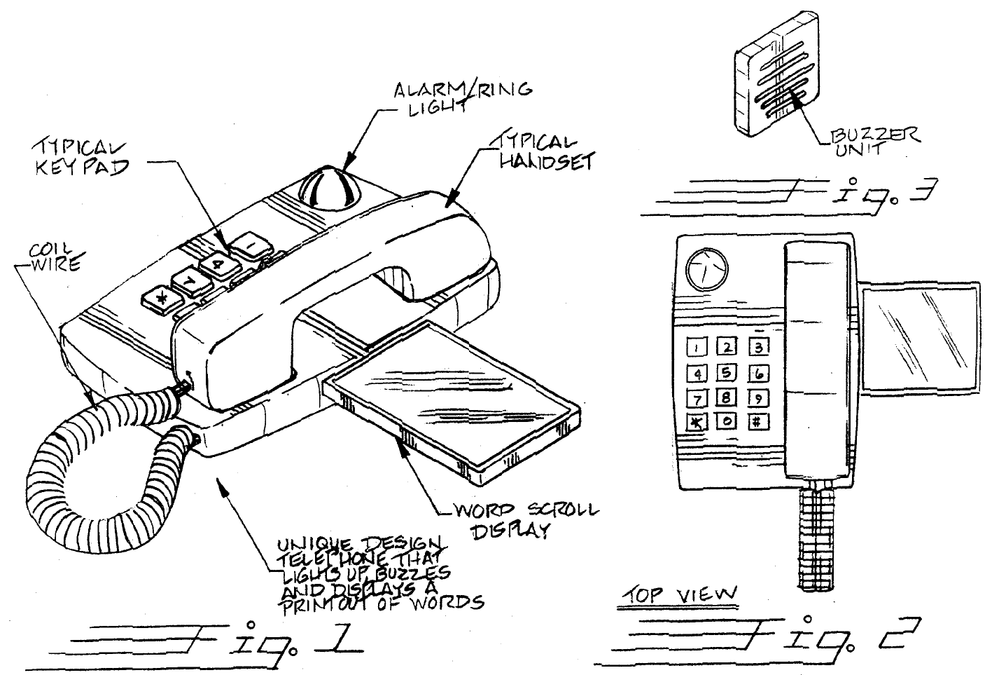

### INVENTION DESCRIPTION & FUNCTIONAL OVERVIEW

To facilitate one's comprehension and understanding of a new product, that idea must be described not only as it exists as an answer to a subsistent problem, but also as it functions physically. Incorporated into this overview is a description of the invention's physical appearance.

Based upon the Inventor's description and our outside research, we will describe the basic overall features, shape and design of Silent Phone. Materials of which the Invention would be produced will also be described.

The design of Silent Phone calls for materials such as plastic, glass, metal and electrical components to be used as its major components.

A large, square telephone would be produced from a durable, high-impact plastic. The phone would be similar in size to conventional telephones.

The telephone would be equipped with a keypad consisting of 12 keys, a light bulb, a buzzer and a glass screen. Other features of Silent Phone would include an internal memory, a speech recognition program, wiring, a circuit board, a long cord that could be plugged into a jack and a handset with a diaphragm to serve as a microphone.

The plastic components of Silent Phone could be produced with the use of injection molding or blow molding. Injection molding is a process that has been in use since the 1920s and provides a versatility almost unmatched in the mass production of any material. It requires that melted plastic be forcefully injected into relatively cool molds. As the plastic begins to harden, it takes on the shape of the mold cavity and, when cool, requires few postmolding operations. Other advantages of this process include its speed of production and its ability to allow multiple parts to be simultaneously molded.

Blow molding in the production of plastic shapes is a form of extrusion, a major technique in the plastics industry. Extrusion is used to push a molten tube, called a parison, into a bottle-shaped mold. Compressed air then forces the parison against the cold walls of the mold, hence the term “blow molding”. Molds ate generally side fed, with the thickness of the plastic controlled by a tapered mandrel (core) or by the means of a variable-orifice die. Continuous extrusion of the plastic is possible through the use of multiple blow molds.

Silent Phone could also be produced in a second version resembling a cell phone. This version of Silent Phone would have a plastic housing, a battery compartment with metal contacts, a metal antenna, an internal circuit board, a screen, a light, a buzzer and a microphone. Other features would include an internal memory with a voice recognition program, a radio transmitter and a radio receiver.

To use Silent Phone, a deaf person would use the keypad of Silent Phone to make a phone call. During the call, the deaf person would speak into the phone. The receiver of the call would respond and the receiver's answer would scroll over the screen. If the deaf person received a call, the buzzer and the light would be activated to warn the deaf person of an incoming phone call.

1. Silent phone has a scroll that shows the message from whom ever is talking on the phone.

2. Silent Phone has a printer to print the phone message.

3. Silent Phone is for the deaf and hearing impaired. It has a light and vibrator That is activated when a call comes in.
